(19) United States
(12) Patent Application Publication
(10) Pub. No.: US 2022/0016926 A1
(43) Pub. Date: Jan. 20, 2022

(54) DripLip

(71) Applicants: Harold Swaringim, O'Fallon, MO (US); Michael Swaringim, O'Fallon, MO (US)

(72) Inventors: Harold Swaringim, O'Fallon, MO (US); Michael Swaringim, O'Fallon, MO (US)

(21) Appl. No.: 17/379,040

(22) Filed: Jul. 19, 2021

Related U.S. Application Data
(60) Provisional application No. 63/053,858, filed on Jul. 20, 2020.

(51) Int. Cl. B44D 3/12

(52) U.S. Cl. CPC B44D 3/128

(57) ABSTRACT

The DripLip has a round shape that fits upon a paint can and retains drips and dribbles. The invention has an upper flange upon a wall that descends to a lower flange perpendicular to the wall. Upon a portion of the lower flange, the invention has a chamber of a generally rectangular cross section. Then upon a portion of the chamber, a forward chamber extends outwardly from the chamber and the rest of the invention. The forward chamber has an inverted generally triangular cross section. The forward chamber opens into the plane of the lower flange. The chamber and the forward chamber retain the liquid remaining from a typical pour from the paint can.

### CROSS-REFERENCE TO RELATED APPLICATION

This non-provisional application claims priority to the pending provisional application Ser. No. 63/053858 filed on Jul. 20, 2020 and all applications have a common inventor and are owned by the same inventors.

### BACKGROUND OF THE INVENTION

The present invention relates to painting equipment in general and more particularly to equipment that reduces spillage and increases drip collection.

Pouring paint from an existing one gallon can and other sizes of containers into a paint tray often leads to paint filling a lid channel in the can or other container. If the lid channel lacks thorough cleanliness, the lid will not seat properly into the channel. With a partly unsealed container, painters become unable to store paint for long periods of time without ruining the paint left in the can or other container. As homeowners and less skilled painters have experienced, placing a lid upon a channel with residual paint in it causes the paint to squirt from beneath the lid, leaking over the side of a can, waste paint, and make a mess, often unexpectedly.

From before the pyramids of Egypt, people have put their mark on walls, ceilings, and a host of other places. Early markings had substances of nearby origin often made on the spot as near cave paintings. In time, people became painters and their substances of marking became paints of wide variety. From the pharaohs to the nobles of the Enlightment, painters followed the vision of their patrons in their artistic endeavors. Some endeavors became masterpieces such as the works of Michelangelo. Master painter Michelangelo depicted human forms in a host of activities often upon ceilings of chapels. Michelangelo, as with other painters, put paints upon his palette for later use on plaster or canvas, tile, and stucco to name a few substrates.

Flowing from the work of artists, paint also appears on buildings. Paint seals a surface and protects that surface as well as the structure beneath from moisture, sun, and the elements. Within a structure, paint serves its protective purpose but also improves the ambience with color and patterns. Use of paint faces its only limit of human creativity. As paint applies to structures, structures may have vast surfaces, such as walls, ceilings, and floors. Such surfaces call for a volume of painter greater than an artist's palette can hold.

Throughout this application, where a masculine pronoun is used, the feminine pronoun is implied.

### Description of the Prior Art

With artists' palettes insufficient for large painting, painters adapted buckets and tubs over the recent centuries. Such storage implements came from nearby water supply wells, barns, and stalls. These buckets and tubs often remained open during and after use. That led to spoilage of paint and prompted painters to use just what they needed for a job. Larger volumes of paint came from barrels but still subject to drying and wasting impediments.

Following developments first in steel making and then in polymers, painters insisted upon better storage containers for their paints, stains, varnishes, sealants, and the like. Buckets and tubs acquired lids and then the manufacturers developed metal cans and ultimately polymer plastic buckets. Painters, particularly in residential settings, took a shine to one gallon cans. Such cans had an all metal construction for many decades. In recent years, one-gallon paint cans have retained their steel lids but upon polymer closed bottom cylinders. In larger residential and many commercial settings, painters use five gallon or larger containers. Such larger containers provide much paint for use to a skilled painter and also supply spraying equipment.

Returning to the humble paint can, a painter, whether professional, semi-professional as a decorator, or a homeowner, has to pour paint from the can into a tray, especially for rolling. Rolling, as we remember, covers a large surface promptly. The tray provides a pitched surface upon which a painter wets the roller in paint for its application to a wall, a ceiling, a floor, a door, and the like. But the painter must still pour the paint. Though paint flows as a liquid, its various viscosities cause it to behave differently from can to can and from water itself. A painter must exercise care when pouring paint from a can.

Alas, even the most skilled painter, let alone homeowners, may spill paint during a pour. The painter tips the can abruptly upward and the paint dribbles down the can. The painter tips the can inattentively and the paint dribbles down the can. The painter tips the can slowly and the paint dribbles outside the tray, upon the drop cloths if present, and then a nearby floor. An astute painter reacts, and takes care of the spill promptly.

Suppliers have provided various lid covers to minimize spillage. The covers fit upon a paint can and provide a spout. Some existing covers accept a metal lid upon them where the lid came from the original paint can. These existing covers nobly guide the pour of paint from a can. But a painter must still show attention to a paint can with an existing cover lest a drip or two escape from the cover. Try as they might, painters still face a risk of dribbles of paint up to outright spills of large portions from a paint can during a moment of distraction or inattention.

Though the preceding description has referred to containers, paint cans, trays, and covers, the description also applies to buckets, jugs, jars, boxes, and related paint storage devices with a round opening for dispensing paint, varnish, stains, and the like liquids. While the above-described devices fulfill their respective, particular objectives and requirements, the aforementioned devices do not describe The DripLip. Therefore, a need exists for new and improved The DripLip that can be used for collecting paint and preventing drips and dribbles. In this regard, the present invention substantially fulfills this need. In this respect, The DripLip according to the present invention substantially departs from the conventional concepts and designs of the prior art, and in doing so provides a device primarily developed for the purpose of storing paint from the nappe and ogee of a pour paint and other fluids from a can.

The DripLip overcomes the above-mentioned disadvantages and drawbacks of the prior art. As such, the general purpose of the present invention, which will be described subsequently in greater detail, is to provide new and improved The DripLip which has all the advantages of the prior art mentioned heretofore and many novel features that result in The DripLip which are not anticipated, rendered obvious, suggested, or even implied by the prior art, either alone or in any combination thereof.

### SUMMARY OF THE INVENTION

The DripLip has a round shape that fits upon a paint can and retains drips and dribbles. The invention has an upper flange upon a wall that descends to a lower flange perpendicular to the wall. Upon a portion of the lower flange, the invention has a chamber of a generally rectangular cross section. Then upon a portion of the chamber, a forward chamber extends outwardly from the chamber and the rest of the invention. The forward chamber has an inverted generally triangular cross section. The forward chamber opens into the plane of the lower flange. The chamber and the forward chamber retain the liquid remaining from a typical pour from the paint can.

The present invention provides painters with an improved paint can cover fitting over a standard paint can, preventing the channel in the rim of the can from filling with paint, and thus prevents leaks and spills because of excess paint exuding from the channel, leaking, and making a mess once more. The present invention also protects the airtight seal of the lid to the channel of the can as it allows for forming the airtight seal again when reinstalling the lid after use of the paint can, ensures the quality of the paint lasts for later use, and includes a circular continuous opening that allows the painter to access the paint or other liquid within the can, or other container. The present invention provides a more convenient and effective method of preserving leftover paint with minimal mess.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved The DripLip that may be easily and efficiently manufactured and marketed to the consuming public.

Still another object of the present invention is to provide The DripLip that fits upon existing one-gallon size paint cans.

Still another object of the present invention is to provide The DripLip that fits upon a rim adapted from a one-gallon size paint can.

Still another object of the present invention is to provide The DripLip that retains paint in an amount compatible with ninety percent of the nappes from one-gallon paint cans after pouring from them has stopped.

Still another object of the present invention is to provide The DripLip that fits over the existing lid channel of a one-gallon paint can.

Still another object of the present invention is to provide The DripLip that has a detachable centerpiece. Still another object of the present invention is to provide The DripLip that has at least one ribbed or knurled grip upon a shelf portion of a flange suitable for gripping by a painter's fingers.

Still another object of the present invention is to provide The DripLip that has one centered guide to visually remind a painter the direction to tip a paint can and to physically urge a nappe of paint in the direction of pour, ultimately to a nearby tray or other container.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is an overhead perspective view of an alternate embodiment of the present invention;

FIG. 2 is a perspective view of the alternate embodiment in use;

FIG. 3 is an inverted side view of the alternate embodiment;

FIG. 4 is an overhead perspective view of the alternate embodiment;

FIG. 5 is an inverted perspective view of the alternate embodiment;

FIG. 6 is a top view of the invention;

FIG. 7 is a bottom view of the invention;

FIG. 8 is a front view of the invention;

FIG. 9 is a back view of the invention;

FIG. 10 is a side view of the invention;

FIG. 11 is a side view of the invention;

FIG. 11a is a section view of the invention; and

FIG. 12 is an exploded view of the invention during its usage.

The same reference numerals refer to the same parts throughout the various figures.

### DESCRIPTION OF THE PREFERRED EMBODIMENT

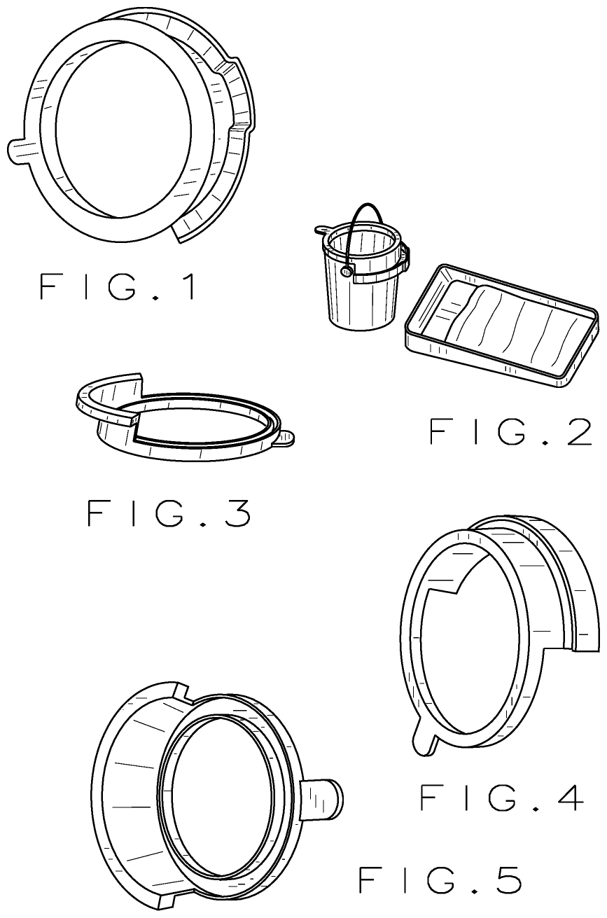

Referring now to the drawings, and particularly to FIGS. 1-12, a preferred embodiment of the DripLip of the present invention is shown by the reference numeral 1.

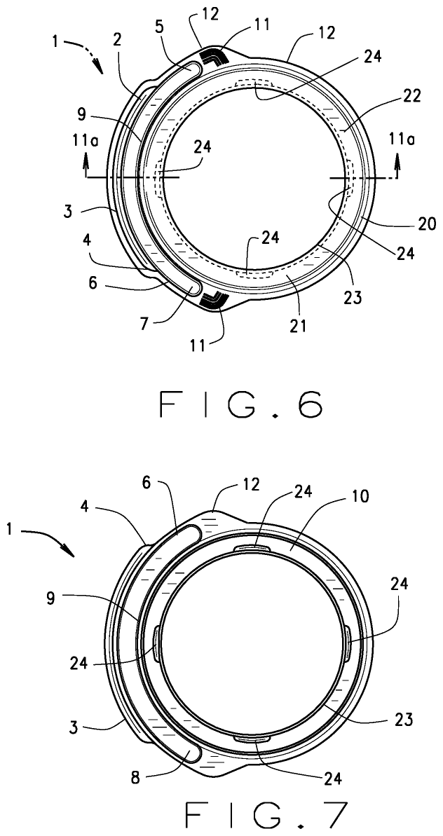

The following description of FIGS. 1-5 presents a simplified summary in order to provide a basic understanding of some aspects of the disclosed invention. This summary is not an extensive overview, and it is not intended to identify key and critical elements and to delineate the scope thereof. Its sole purpose is to present some concepts in a simplified form as a prelude to the more detailed description that presents later in FIGS. 6-12.

The DripLip takes the form of a modified paint can cover. Though this description refers to paint, a panoply of fluids may also see use from this invention. Though the word paint sees plenty of usage in this description other fluids are anticipated. The present invention has a generally circular disposable and lightweight polymer, or plastic, cover that prevents the channel of a paint can from filling with paint prevents paint from spilling onto the surrounding area near the can and wasting unused paint. The DripLip covers the lid channel of a paint can and partially lines the interior beneath the lid channel. The present invention also has its generally circular continuous opening that allows a user to access the paint or other liquid within the can. A painter can pour additional paint, if needed, without worry of filling the lip of the can with excess paint. The spill prevention ensures all leftover paint can see a future use without mess and waste. Though this description refers to a painter, the word anticipates other users for the invention such as artists, roadway stripers, decorators, and the like.

As happens, exact size, measurements, construction, design, and specifications may vary during later development and manufacturing of the present invention. FIGS. 1-5 show the device of the present invention from multiple views, including perspectives. FIG. 1 is an overhead perspective view of an alternate embodiment of the present invention 1. FIG. 2 is a perspective view of the alternate embodiment of the invention 1 in use upon a paint can C adjacent to a tray T. FIG. 3 is an inverted side view of the alternate embodiment of the invention 1. FIG. 4 is an overhead perspective view of the invention's, as at 1, alternate embodiment. FIG. 5 is an inverted perspective view of the alternate embodiment of the invention 1 partially opposite that of FIG. 4.

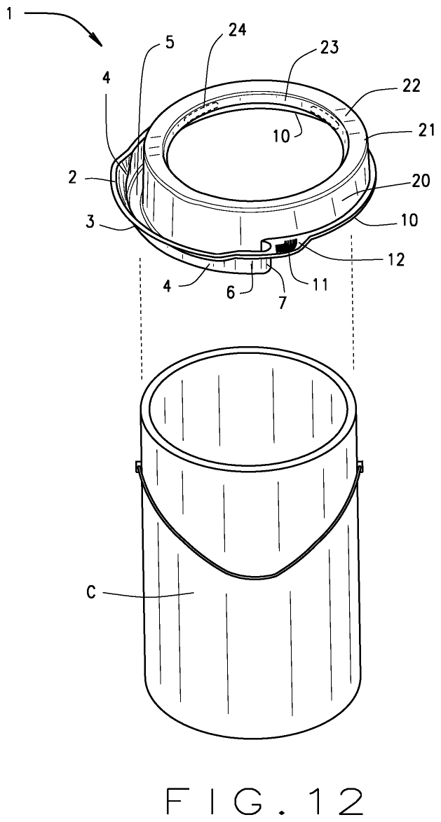

Turning to FIG. 6 showing a top view of the invention, the invention 1 has a round upper flange 22 with a width generally less than an outer diameter of the upper flange. The upper flange has an annular form when viewed from above. The narrow width of the upper flange allows for placement of a lid during manufacturing, shipping, storage, and eventual sale of the invention, The DripLip. During usage, the upper flange lays flat upon a lid channel of a paint can and makes contact upon the entire circumference of the lid channel. Upon removing the lid, the invention appears as shown. The upper flange has an inside diameter and an outside diameter greater than the inside diameter. Upon the interior of the upper flange, the upper flange has an inner rim 23 at the inside diameter. The inner rim has at least three, here showing four, tabs 24 beneath it upon the interior face of wall, also see FIG. 11a, supra. The tabs permit a grasp of the invention upon a paint can beneath a lid channel, as later shown in FIG. 12. Opposite the inner rim, the upper flange 22 has its outer edge 21 at the outside diameter. The outer edge and the inner rim make the upper flange have a generally annular form. Descending from the outer edge 21, the invention has its wall 20 generally of a cylindrical form of the outside diameter of the upper flange 22. The wall has its height into the plane of this figure. In support of nesting, the wall attains a frusto-conical shape. The inner rim, the upper flange, the outer edge, and the wall cooperate so that The DripLip fits snugly upon the lid channel at the top of a paint can.

The wall flares outwardly spaced below the upper flange and into a lower flange 10. The lower flange 10 extends outwardly from the wall around the invention upon a plane perpendicular to the wall 20. Presuming a paint can to the left of the figure, the lower flange approaches a presumed paint can to within ninety degrees of rotation from the center of the invention. Towards the top and to the left of the figure, the lower flange widens to at least double its previous diameter for a grip 11 upon a shelf 12 with the grip formed of ridges, ribs, or knurling, as shown though alternate surface textures are foreseen to aid a painter. The lower flange rotates beyond the grip 11, here, counterclockwise, to a shelf 12. Alternatively, the shelf has the same width as the grip but without surface texture. In rotation away from the shelf, the lower flange then starts a chamber 5 that further extends into the plane of this figure beyond that of the lower flange. The chamber extends outwardly from the wall 20 and from the center of the invention. The chamber has an arcuate form that follows the curvature of the wall 20. As later shown, the chamber has its width, generally constant, and its depth generally constant. The chamber's width and depth cooperate to form a rectangular shaped cross section. Further in clockwise rotation along the chamber, a forward chamber 2 extends outwardly from the chamber. The forward chamber extends for at least one half of the length of the chamber but less than the full length of the chamber.

The forward chamber also follows the curvature of the wall and it has an arcuate form that follows the chamber also. The forward chamber 2 and the chamber 5 continue in rotation towards the lower left of the figure.

The forward chamber 2 has a forward wall 3 tipped outwardly from the rest of the invention, that is outwardly from the center of the invention. The forward wall has a flat shape from the plane of the lower flange 10 downwardly, that is, towards the chamber 2. The forward wall forms the forward chamber at a radial wall 4. The radial wall has a generally inverted triangular shape extending from the lower flange to the chamber, as later shown. The lower edge of the forward wall and the inside edge of the radial wall join to an outer wall 6 forming the exterior of the chamber. The outer wall descends beneath the forward chamber 2 to a base 8 as later shown in FIG. 7. The outer wall continues further in rotation from the radial wall and has a greater height away from the radial wall. The outer wall extends from the lower flange 10 into the plane of the figure. The outer wall continues and follows the curvature of the wall 20 to a rounded end 7 denoting the terminus of the chamber 5 and the outer wall has an arcuate form. The rounded end curves inwardly to an inner wall 9 the defines the opposite boundary of the chamber 5 from the forward chamber 2 and the outer wall 6. The inner wall 9 defines the length of the chamber 5 as it spans between the shelves 12 just outside the grips 11. The shelves are mutually spaced apart and outward from the chamber as shown. The inner wall also extends from the lower flange 10 into the plane of the figure and defines the height of the chamber. The height of the chamber exceeds that of the forward chamber as shown. Preferably, the invention has single axis symmetry centered upon the forward chamber. As the invention has that symmetry, the preceding description applies to both the grips, tabs, rounded ends, and portions of the forward chamber, chamber, forward wall, radial walls, outer wall, and inner wall as shown in the top and bottom of the figure. Turning the invention 1 over, FIG. 7 shows a bottom view of it, that is, without a nearby paint can. In the background towards the center of the figure, the invention has its inner rim 23 generally round. In an alternate embodiment, the invention has four tabs 24 symmetrically spaced about the inner rim of the upper flange. Outwardly from the inner rim, the lower flange 10 extends at the plane of this figure. Towards the left of the figure, the lower flange 10 has the two tabs 12 equally spaced apart in rotation and generally symmetric about the center of the forward wall 3. Within the tabs, the figure shows the base 8 of curved form following the curve of the wall 20 previously shown. The base has a generally flat form in the foreground of this figure. The base has the inner wall 9, the rounded ends 7, and the outer wall 6 beneath it and extending to the lower flange 10. Centered upon the base and shown towards the left, the forward wall 3 of the forward chamber appears. The forward wall extends from the outer wall below the base in this figure upwardly toward the lower flange. The forward wall has the two radial walls 4 flanking it, that is mutually spaced apart in rotation about the center of the invention. The forward wall, the outer wall, the inner wall, the forward chamber, the chamber, the wall and the outer edge each have a slight angular orientation or bevel that permits nesting of a plurality of the invention. To further promote nesting, the invention has its wall forming a frusto-conical shape.

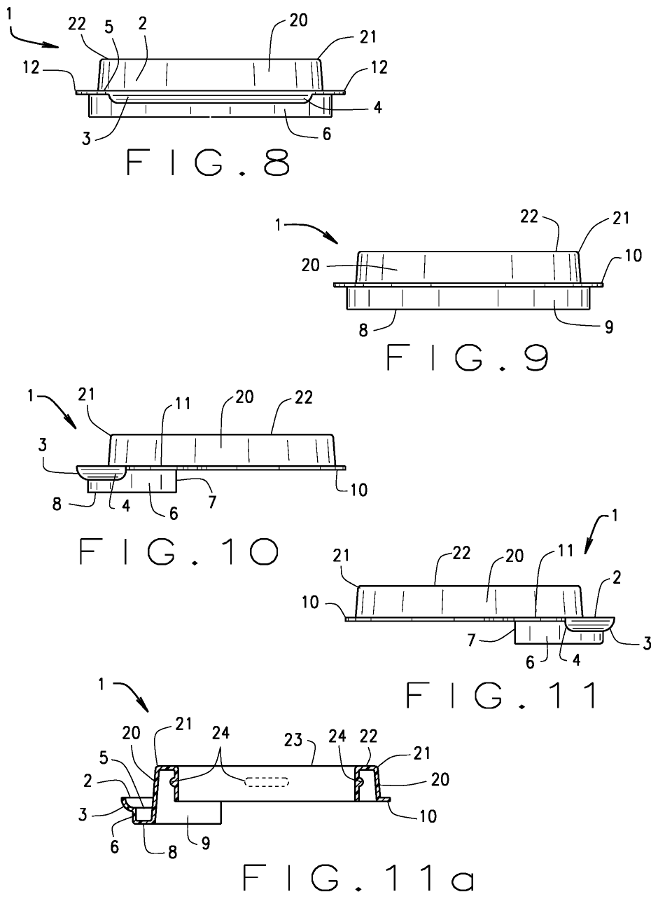

Ready to paint? FIG. 8 shows a front view of the invention just before paint or other liquid may flow over it. With a painter tipping the can, the paint would flow generally centered upon the inner rim 23 and over the upper flange 22. The paint flows over the upper flange outward and reaches the outer edge 21 that encircles the upper flange as previously shown. The outer edge has a curved form and transitions downwardly to the wall 20 at a slight bevel to the plane of the outer edge. The wall extends around the other edge and thus displays a somewhat trapezoidal shape in this figure. The wall descends to the lower flange 10 with its two spaced apart grips 11 extending outermost in this view. Below the grips 11, the outer wall 6 descends forming the chamber 5 spanning from left to right in this figure. Centered upon the outer wall 6, the forward chamber 2 communicates behind the forward wall 3 into the chamber. The radial walls 4 cabin the forward wall 3 forming the forward chamber within them. When the painter concludes pouring paint, the painter tips the can upward and residual paint, or other liquid, collects in the forward chamber and the chamber and both cooperate to mutually retain it.

Turning the invention 1, FIG. 9 shows a back view as a painter would see the invention during tipping of a paint can with the invention upon it. The DripLip has its upper flange 22 around the invention denoted by the outer edge 21. Depending from the outer edge 21 in this view, the invention has the wall 20 that wraps around the invention at an obtuse angle to the plane of the upper flange. The angle of the wall permits nesting of the invention. The wall then merges into the lower flange 10 where the lower flange generally has parallel orientation to the upper flange. Beneath the lower flange in this view the chamber 5 descends and shows the inner wall 9 approaching and merging into the base 8 opposite the upper flange. The chamber extends left to right in this figure at slightly less than the diameter of the invention.

Turning the invention ninety degrees in rotation from the view of FIG. 9, FIG. 10 shows a side vide of The DripLip with the forward wall 3 towards the left. With the lower flange 10 here shown in a horizontal orientation, the invention may have seen use and may store paint or other liquid within the forward chamber 2 and the chamber 5 behind it. The lower flange 10 has a grip 11 left of center and the wall 20 extending upwardly from it at an angle suitable for nesting the invention. The wall reaches its height and merges with the other edge 21. The other edge has the upper flange 22 within it.

Below the lower flange 10, the forward chamber towards the left has its forward wall 3 extending downwardly and inwardly. The forward wall merges with the radial wall 4 here show in its triangular shape. The radial end then merges into the outer wall 6 of the chamber 5. The outer wall then extends downwardly from the lower flange as it curves to follow the lower flange. The outer wall merges into the base 8 at an angle suitable for nesting. The base has a generally flat orientation, here shown parallel to the lower flange. The outer wall curves to the right and merges with the rounded end 7. The round end spans from the base up to the lower flange as shown.

Turning the invention ninety degrees in rotation from the view of FIG. 9 oppositely from that of FIG. 10, FIG. 11 shows a side vide of The DripLip with the forward wall 3 towards the right. As described in FIG. 10, the invention has its lower flange 10 supporting the wall 20, outer edge 21, and upper flange 22 above it. Below the lower flange, the forward wall 3 and the radial walls 4 form the forward chamber 2 that communicates into the chamber 5. The chamber forms within the outer wall 6 upon the base 8 and cabined with the rounded ends 7. The lower flange has a perpendicular orientation to the chamber.

Let's explore how the forward chamber 2 communicates to the chamber 5 for collecting and storing drips and dribbles of paint or other liquid in the sectional view of FIG. 11a. From the left of the figure, The DripLip begins with the lower flange 10 here at its most forward orientation beneath the center over which the paint flows out during pouring and this collects upon returning a can and the invention upright. From the lower flange, the forward wall 3 descends at a near acute angle and inward to the outer wall 6. The outer wall descends further to the base 8 reaching the maximum height of the invention. The base extends inward again to the inner wall. The inner wall has a spaced apart position from the outer wall and the forward wall. In this view the inner wall and the outer wall have slight mutually outward angles to permit nesting of the forward chamber and the chamber.

The inner wall continues upwardly from the base to the lower flange 10 and transition to the wall 20. The wall extends further upward to the outer edge 21 that rounds over to the upper flange 22 at the maximum height of the invention. The upper flange has an obtuse angle to the wall that permits nesting. The upper flange curves around the invention as previously shown. Along that, the upper flange has the inner rim 23 that has tabs 24 beneath it. The tabs assist in gripping the paint can, beneath the lid channel, during usage of the invention. More precisely, the tabs 24 have locations equally spaced upon the interior face of the wall 20 and below the inner rim 23. The inner rim continues toward the right of the figure to another portion of upper flange 22 opposite the forward wall 3. The wall 20 descends from the outer edge 21 to the lower flange 10 on the far right of the figure. The lower flange portions on the left and the right of this figure have a coplanar orientation. Preferably, the inner rim 23 and the outer edge 21 have a rounded form that guides liquid, such as paint, in the forward chamber and the chamber. The rounding of the inner rim and the outer edge provide a smooth transition of the upper flange to both of them and liquid flowing out of the invention has little turbulence imparted to it. The forward wall, the outer wall, the inner wall, the forward chamber, the chamber, and the wall each have a slight angular orientation or bevel that permits nesting of a plurality of the invention. To further promote nesting, the invention has its various wall forming a frusto-conical shape. The various walls and edges have an outward angular orientation as shown in this figure that permits nesting of one The DripLip upon a stack of others.

After many references in the above description, FIG. 12 shows an exploded view of a paint C about to receive The DripLip 1. The invention 1 has its upper flange 22 oriented upwardly in this view and has its inner rim 23 descending from it with two tabs 24 shown spaced around the inner rim, ready to grasp the paint can C. Opposite the inner rim, the outer flange 22 has its outer edge 21 the transitions to the wall 20 that extends around the invention. For most of the distance around the wall, a lower flange 10 extends slightly outwardly.

For slightly less than half of the distance around the lower flange 10, the lower flange has its chamber 5 beneath and outwardly from it. The chamber 5 has the forward chamber 2 extending outwardly from a centered portion of it. The forward chamber has its forward wall 3 at an angle away from the wall 20. As the forward wall approaches the chamber 5, it has radial walls 4 of a triangular shape shown towards the upper right. Each terminus of the forward wall has a radial wall. The radial walls merge into the outer wall 6 and the outer wall descends to the base 8 of the chamber 5. The chamber has its rounded ends 7 that merge into the inner wall 9. The inner wall then extends upwardly from the base to the outer edge 21.

As before, the outer flange continues and transitions to the inner wall above the chamber. During usage, a painter places The DripLip upon the lid channel of an opened paint can. The painter orients the forward chamber in the desired direction of pour, typically away from the paint can's handle. The painter then tips the paint can and pours as desired. With a pour completed, the painter turns the paint can upright. That draws the nappe of residual paint against the forward wall and then into the forward chamber and on into the chamber. The forward chamber and the chamber have sufficient volume and space to contain at least three quarters of the typical nappes of residual paint.

The description above includes examples of the claimed subject matter. It remains beyond possible to describe every conceivable combination of components or methodologies for purposes of describing the claimed subject matter. But one of ordinary skill in the art may recognize that many further combinations and permutations of the claimed subject matter may become possible. Accordingly, the claimed subject matter embraces all such alterations, modifications, and variations that fall with the spirit and scope of the appended claims. Furthermore, to the extent that the term “includes” sees use in the detailed description and the claims, “includes” becomes inclusive in a manner similar to the term “comprising” as “comprising” has its interpretation when employed as a transition word in the appended claims.

The foregoing descriptions of specific embodiments of the present invention appeared for purposes of illustration and description. These descriptions need not exhaust all forms and limit the present invention to the precise forms disclosed, and many modifications and variations may take form in light of the above teaching. The exemplary embodiment described above became chosen and described in order to clearly explain the principles of the present invention and its practical application in industry, to thereby enable others skilled in the art to best utilize the present invention and its various embodiments with various modifications as suited to the particular use contemplated.

While a preferred embodiment of The DripLip has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The DripLip may have steel, alloy, polymer, ceramic, or a composite material for its primary construction. For example, any suitable sturdy material such as plastic, polymer, metal, composite, or another variety of hybrid material may be used in any of the invention's components. The invention has a construction of a rugged, durable material that resists imparted torsion, impact loads, jams, water, groundwater, and petroleum products.

Although providing The DripLip, it should be appreciated that The DripLip herein described is also suitable for construction sites, oilfields, residential locations, commercial property, industrial plants, farms, ranches, warehouses, garages, select mines, and the like where The DripLip user can put them to work.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A paint retaining device, comprising:
a chamber of arcuate form;
a forward chamber upon said chamber outwardly, said forward chamber having an arcuate form following that of said chamber;
a lower flange outward of said chamber and said forward chamber, said lower flange being perpendicular to said chamber;
a wall extending upward from said chamber and along said lower flange, said lower flange extending substantially around said wall;
an outer edge transitioning said wall to an upper flange and having an annular form;
an inner rim upon said upper flange opposite said outer edge; and
wherein said device is adapted to guide a liquid over said inner rim and said upper flange and wherein said chamber and said forward chamber are adapted to mutually retain liquid.

2. The paint retaining device of claim 1 further comprising:
said lower flange having two spaced apart shelves outward from said chamber; and
said inner rim having four tabs extending inward of said device.

3. The paint retaining device of claim 1 further comprising:
each of said shelves having grips thereon.

4. The paint retaining device of claim 1 further comprising:
said forward chamber including a forward wall tipped outward from a center of said paint retaining device and two radial walls mutually spaced apart in rotation about the center of said paint retaining device;
each of said radial walls having a triangular shapes extending outward form said chamber; and
said forward chamber having a height less than said chamber.

5. The paint retaining device of claim 4 further comprising:
said chamber including an arcuate outer wall following said wall, said outer wall receiving said forward wall and said radial walls of said forward chamber, an inner wall spaced apart from said outer wall, said inner wall extending upwardly and merging into said wall, two rounded ends mutually spaced apart in rotation about the center of said paint retaining device, each of said rounded ends spanning from said inner wall to said outer wall, and a base spanning between said inner wall, said outer wall, and said rounded ends; and
said chamber having a length greater than that of said forward chamber.

6. The paint retaining device of claim 1 further comprising:
said outer edge and said inner rim being rounded to guide a liquid into said chamber and said forward chamber, wherein said outer edge and said inner rim impart little turbulence into liquid flowing upon them; and
said forward chamber, and said chamber being mutually concentric.

7. The paint retaining device of claim 5 further comprising:
said forward wall, said inner wall, said outer wall, said wall, said upper flange, and said inner rim each having an angular orientation for nesting of said paint retaining device.

8. The paint retaining device of claim 6 further comprising:
said outer edge rounding over, said inner rim rounding over, and said outer edge and said inner rim attaining a smooth transition to said upper flange; and
said wall forming a frusto-conical shape.

9. A paint retaining device, comprising:
a wall having an open shape, a circumference of said wall, an upper flange upon said wall and perpendicular to said wall, and an inner rim of said upper flange extending within said wall;
a lower flange extending radially outward of said wall and spaced beneath said upper flange;
said wall extending beneath said lower flange for a portion of the circumference of said wall and forming a chamber extending radially outward from said wall, said chamber having arcuate form;
said chamber having a forward chamber extending outwardly therefrom, said forward chamber having an arcuate form following that of said chamber;
said upper flange having an annular form, an outer edge transitioning to said wall, and said outer edge being outward from said inner rim; and
wherein said device is adapted to guide a liquid upon said inner rim, said upper flange, and over said outer edge into said chamber and said chamber and said forward chamber retain liquid.

10. The paint retaining device of claim 9 further comprising:
said lower flange having two spaced apart shelves outward from said chamber; and
said inner rim having four tabs extending inward of said device where said tabs are adapted to fit beneath a lid channel.

11. The paint retaining device of claim 10 further comprising:
each of said shelves having grips thereon.

12. The paint retaining device of claim 9 further comprising:
said chamber including an arcuate outer wall following said wall extending beneath said lower flange as an inner wall spaced apart from said outer wall, two rounded ends mutually spaced apart, each of said rounded ends spanning from said inner wall to said outer wall, and a base spanning between said inner wall, said outer wall, and said rounded ends; and
said chamber having a length less than half of the circumference of said wall.

13. The paint retaining device of claim 12 further comprising:
said forward chamber including a forward wall tipped outward from said inner wall and two radial walls mutually spaced, each of said radial walls having a triangular shapes extending outward from said inner wall and said forward chamber extending outward from said chamber; and
said forward chamber having a height less than said chamber and less length than said chamber.

14. The paint retaining device of claim 13 further comprising:
said outer edge and said inner rim being rounded to guide a liquid into said chamber and said forward chamber, wherein said outer edge and said inner rim impart little turbulence into liquid flowing upon them; and
said forward chamber, and said chamber being mutually concentric.

15. The paint retaining device of claim 14 further comprising:
said paint retaining device having a frusto-conical shape; and
said forward wall, said inner wall, said outer wall, and said wall each having an angular orientation for nesting of said paint retaining device.

16. The paint retaining device of claim 13 further comprising:
said outer edge and said inner rim attaining a smooth transition to said upper flange.

17. A paint retaining device, comprising:
a wall having an open shape, a circumference of said wall, an upper flange upon said wall and perpendicular to said wall, and an inner rim of said upper flange extending within said wall, said paint retaining device having a frusto-conical shape;
a lower flange extending radially outward of said wall and spaced beneath said upper flange;
said wall extending beneath said lower flange for a portion of the circumference of said wall and forming a chamber extending radially outward from said wall, said chamber having arcuate form;
said chamber having a forward chamber extending outwardly therefrom, said forward chamber having an arcuate form following that of said chamber;
said chamber including an arcuate outer wall following said wall extending beneath said lower flange as an inner wall spaced apart from said outer wall, two rounded ends mutually spaced apart, each of said rounded ends spanning from said inner wall to said outer wall, and a base spanning between said inner wall, said outer wall, and said rounded ends;
said chamber having a length less than half of the circumference of said wall;
said forward chamber including a forward wall tipped outward from said inner wall and two radial walls mutually spaced, each of said radial walls having a triangular shapes extending outward from said inner wall and said forward chamber extending outward from said chamber;
said forward chamber having a height less than said chamber and less length than said chamber;
said upper flange having an annular form, an outer edge transitioning to said wall and being outward from said inner rim;
said lower flange having two spaced apart shelves outward from said chamber; each of said shelves having grips thereon;
said inner rim having four tabs extending inward of said wall where said tabs are adapted to fit beneath a lid channel;
said forward chamber being centered upon said chamber; and
wherein said device is adapted to guide a liquid over said inner rim and said upper flange and wherein said chamber and said forward chamber are adapted to cooperatively retain liquid.

18. The paint retaining device of claim 17 further comprising:
said forward wall, said inner wall, said outer wall, and said wall, each having an angular orientation for nesting of said paint retaining device; and
said outer edge rounding over, said inner rim rounding over, and said outer edge and said inner rim attaining a smooth transition to said upper flange.
